(19) United States
(12) Patent Application Publication
(10) Pub. No.: US 2026/0310585 A1
(43) Pub. Date: Oct. 8, 2026

(54) FRAMEWORK FOR SOFTWARE PATCH DEPLOYMENT

(71) Applicant: SAP SE, Walldorf (DE)

(72) Inventors: Anushrutha Harogolige JAYAPRAKASH, Bangalore (IN); Andreas SCHOKNECHT, Linkenheim-Hochstetten (DE); Xiaochun XU, Heidelberg (DE)

(21) Appl. No.: 19/173,249

(22) Filed: Apr. 8, 2025

(51) Int. Cl. G06F 11/3668; G06F 8/65

(52) U.S. Cl. CPC G06F 11/368; G06F 8/65

(57) ABSTRACT

A system and method include reception of a first software code patch for a software application in a buffer, determination, in response to reception of the first software code patch, that a regression test of the software application is executing, reception of a second software code patch for the software application in the buffer, determination, in response to reception of the second software code patch, that a regression test of the software application is not executing and, in response to the determination that the regression test is not executing, automatic execution of a regression test of the software application patched with the first software code patch and the second software code patch. These features allow regression tests of all patches from end-to-end and accounting for interdependencies, to ensure that the patched application will function as desired.

### BACKGROUND

Modern organizations employ various software applications to manage and automate their core processes. These applications centralize organizational data and facilitate real-time information sharing, thereby improving efficiency, decision-making, and operational control. Applications may be provided to an organization by one or more software vendors and are often customizable to the specific needs of the organization.

Applications are often updated to fix bugs, add new functionalities or refine existing functionalities. An update may consist of the deployment of one or more patches to an already-deployed application. Updates may proceed according to a predetermined upgrade schedule and/or in an ad-hoc manner. It is desirable to promptly deploy patches which are needed to address a critical bug or an otherwise-disruptive issue (hereinafter referred to as emergency patches).

Conventionally, deployment of an emergency patch begins with reception of a customer report describing a bug or other issue. A development team determines whether the bug/issue is critical and, if so, generates a patch for resolving the bug/issue. The patch undergoes static code checks and unit testing. During a fixed evening interval, all tested patches are deployed to a deployment test landscape and the thusly-patched application undergoes regression testing. If an emergency patch is not yet available (e.g., under development, undergoing static code checks or undergoing unit testing) at the beginning of the fixed interval, the patch will not be deployed and tested in the deployment test landscape until the next evening's fixed interval. Organizations may experience dissatisfaction with the application due to the resulting delay between reporting and implementation of a resolution.

Systems are desired to deploy high-quality emergency patches in a timely manner. Such systems may increase customer satisfaction and organizational performance.

### BRIEF DESCRIPTION OF THE DRAWINGS

FIG. 1 illustrates an architecture for software patch development and testing according to some embodiments.

FIG. 2 is a flow diagram of a process to develop a software patch according to some embodiments.

FIG. 3 is a flow diagram of a process to test and deploy one or more software patches according to some embodiments.

FIGS. 4a-4g illustrate testing of software patches according to some embodiments.

FIG. 5 illustrates an architecture for software patch development and testing according to some embodiments.

FIG. 6 is a diagram of a cloud-based implementation according to some embodiments.

### DETAILED DESCRIPTION

The following description is provided to enable any person in the art to make and use the described embodiments. Various modifications, however, will be readily-apparent to those in the art.

Some embodiments enhance the patch deployment process so as to increase the frequency with which patches may be deployed to customer systems. Embodiments may increase the ratio of high-quality emergency patches which can be deployed to customers within one day of patch development.

According to some embodiments, an incident report relating to a software application is received. A software code patch is developed for the software application in response to the incident report. The software code patch is transported to a buffer of a test landscape and, in response, it may be determined that a first regression test of the software application is executing in the test landscape. Once the first regression test completes, another regression test is executed using any patches which exist in the buffer. For example, assuming that a second software code patch is received in the buffer while the first regression test is being executed, completion of the first regression test results in automatic execution of a regression test of the software application patched with the first software code patch and the second software code patch.

Moreover, an incident report received from any single customer of the software application may result in fast deployment of a high-quality patched software application to all customers of the software application.

Embodiments may provide local static code checks and local unit tests prior to transporting a patch to the buffer of the test landscape. In some aspects, a test landscape includes a static code checking landscape and a unit testing landscape. After completion of local static code checks and unit tests on a software patch, the patch may be stored in a buffer of the static code checking landscape to perform a static code check on the entire software application and software patch. Similarly, the patch may be stored in a buffer of the unit testing landscape to perform unit tests on the entire software application and software patch. If these static code checks and unit tests are passed, the patch may be transported to the test landscape for regression testing as described above.

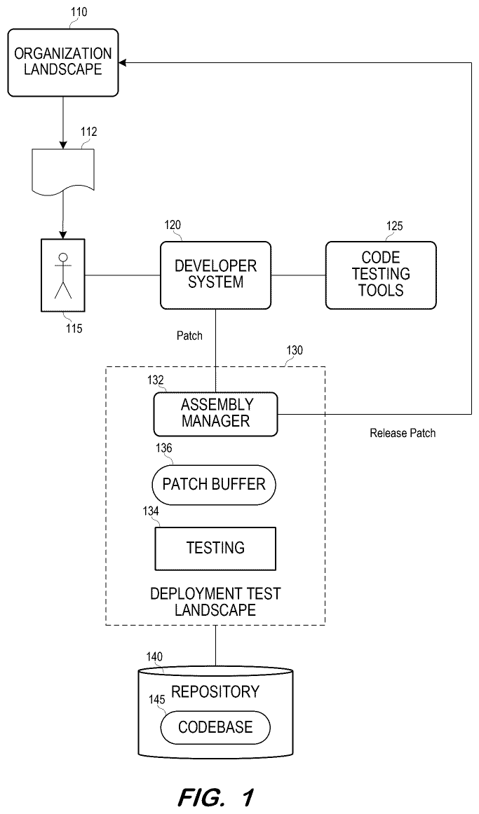

FIG. 1 illustrates an architecture according to some embodiments. Each of the illustrated components of FIG. 1 may be implemented using any suitable combinations of computing hardware and/or software that are or become known. Such combinations may include cloud-based implementations in which computing resources are virtualized and allocated elastically. In some embodiments, two or more components are implemented by a single computing device.

Organization landscape 110 may be operated by an organization or on behalf of an organization to provide desired functionality to the organization. Landscape 110 may support one or more development tenants, test tenants and productive tenants. Landscape 110 may include any suitable hardware, software, network, and data infrastructure components.

Hardware components of landscape 110 may include on-premise and/or cloud-based servers (e.g., server clusters) to host software applications, databases, and middleware, storage systems for storing application data, logs, and backups, and user devices such as workstations, laptops, mobile devices, and thin clients for accessing the software applications. Organization landscape 110 may also include LAN/WAN components, gateways and load balancers for securely directing network traffic. The databases of landscape 110 may comprise relational databases, blob stores, data warehouses, data lakes, etc.

Landscape 110 may execute one or more software applications. In some embodiments, one of the software applications is an enterprise resource planning application. Embodiments are not limited thereto. At least one of the software applications executed by landscape 110 is supported by a software development entity which provides bug fixes, upgrades and troubleshooting services related to the at least one software application.

In this regard, organization landscape 110 may output incident report 112. Incident report 112 may specify an issue related to a software application executed by landscape 110. Incident report 110 may include a description of a suspected problem or bug in the software application, a desired new functionality, or any other issue which may require an update to the software application. Incident report 112 may also include a severity of the issue or other indication of the urgency of a resolution.

Incident report 112 may be generated automatically by organization landscape 110, and/or by a user of landscape 110. The user may be an end-user of the software application (in which case incident report 112 may comprise a helpdesk ticket), an IT administrator of landscape 110 who uses a dedicated communication channel to generate and transmit incident report 112, or any other user. The contents of incident report 112 may be submitted orally (e.g., via a telephone call) or in any suitable manner. Incident report 112 may be transmitted upon creation, within periodically-sent batches of incident reports, or otherwise.

Developer 115 receives incident report 112. Developer 115 may comprise one or more people tasked to evaluate and triage received incident reports. Developer 115 may also be responsible for developing a software patch to resolve the issue(s) described in incident report 112. In some embodiments, an issue may be raised via mechanisms other than incident reports, including by developers of the software application.

In one example, developer 115 receives incident report 112 and determines whether the described issue constitutes an emergency (e.g., should be resolved as soon as possible). Developer 115 may consider any suitable factors in this determination, such as, for example, a service level agreement of the organization, whether the issue has rendered the software application unusable, and whether the issue is a bug or a feature request. If the described issue constitutes an emergency, developer 115 determines whether the issue can be resolved via a remotely-deployable software patch. According to some embodiments, certain processes described herein are initiated only if the issue constitutes an emergency and can be resolved via a remotely-deployable software patch.

Developer 115 may operate developer system 120 to develop a software patch for resolving the issue of incident report 112. The software patch may resolve more than one issue described by one or more incident reports. Developer system 120 may comprise any software development environment that is or becomes known. Developer system 120 may execute several software applications for facilitating software development. Developer system 120 may comprise a client application executing on a device local to developer 120 and a corresponding back-end application executing on a remote server. Developer system 120 may communicate with a code repository including code of the software application.

Developer system 120 may utilize code testing tools 125 to perform local tests on the developed software patch. The local tests, according to some embodiments, may comprise static code checks and unit tests on the portions of the software application which are changed by the developed patch. Static code checks, also known as static code analysis, involve examining source code without executing the source code to identify bugs, security vulnerabilities, coding standard violations, maintainability concerns, and/or other potential problems. Code testing tools 125 may include automated tools to perform static code checks to analyze code structure, syntax, and patterns.

Unit tests verify individual units (smallest testable parts) of a software application, such as functions, methods, or classes. Unit tests are intended to ensure that a unit of a software application behaves as expected in isolation from the rest of the software application.

Deployment test landscape 130 includes hardware and software elements to facilitate software application testing. Assembly manager 132 generally ensures that all components of a software application interoperate correctly and meet quality standards before the software application is deployed into production environments. In particular, assembly manager 132 may manage dependencies between components, direct code packaging and building, confirm the stability of assembled software, and coordinate build testing.

Assembly manager 132 instructs testing component 134 to execute tests on patched and assembled software applications and receives testing results therefrom. Testing component 134 may perform regression tests on a software application, including but not limited to smoke tests and UI tests.

Assembly manager 132 may access codebase 145 of the software application in order to patch and build the software application. Codebase 145 may include code of various branches of the software application as is known in the art. Codebase 145 is stored in code repository 140, which may store codebases of other software applications and managed versioning, check-ins/outs, etc.

Assembly manager 132 may receive the patches generated and locally-tested by developer system 120. In response to the received patch, assembly manager 132 determines whether testing component 134 is currently executing a regression test. If so, assembly manager 132 stores the patch in patch buffer 136. Patch buffer 136 may comprise a random-access memory area which is backed up to a persistence. According to some embodiments, the patch is received by patch buffer 136, which triggers assembly manager 132 to determine whether regression testing is currently ongoing.

Patch buffer 136 may continue to receive patches while regression testing is ongoing. Once it is determined that regression testing is complete, assembly manager 132 patches the software application with all patches currently stored in patch buffer 136, builds the patched software application, deploys the software application to deployment test landscape 130, and instructs testing component 134 to execute regression testing on the deployed software application.

Assembly manager 132 may receive the results of regression testing performed by testing component 134. The results may provide details of any errors that occurred during any regression tests. Assembly manager 132 may return the results to developer system 120, transmit an e-mail or other communication to an administrative group, etc. Based on the results, it may be determined to deploy the patch to organization landscape 110. Patch deployment may comprise installing the patched software application to landscape 110, updating the software application in-place based on the patch, or any other technique.

According to some embodiments, assembly manager 132 determines whether or not to deploy tested patches to landscape 110 depending on the test results. For example, if all tests have passed, assembly manager 132 may issue an instruction to an appropriate deployment system to deploy the patched software application to organization landscape 110. In contrast to conventional systems, the foregoing features increase the frequency with which requested patches may be deployed to organization landscapes.

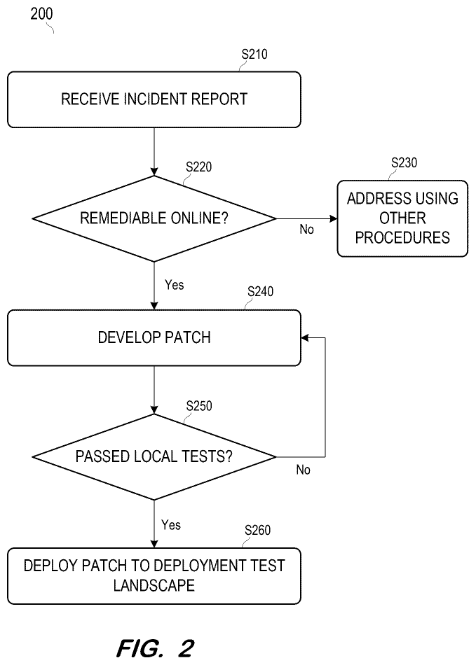

FIG. 2 is a flow diagram of process 200 to develop a software patch according to some embodiments. Process 200 and the other processes described herein may be performed using any suitable combination of hardware and software. Software program code embodying these processes may be stored by any non-transitory tangible medium, including a fixed disk, a volatile or non-volatile random-access memory, a DVD, a Flash drive, or a magnetic tape, and executed by any number of processing units, including but not limited to processors, processor cores, and processor threads. Such processors, processor cores, and processor threads may be implemented by a virtual machine provisioned in a cloud-based architecture. Embodiments are not limited to the examples described below.

Initially, at S210, an incident report associated with a software application is received. The incident report may be received from a customer organization, for example as a helpdesk ticket. The incident report may be generated by a developer of the software application based on internal use and/or testing. The incident report need not describe an “incident” per se, but may indicate any issue such as an error, a discrepancy, a feature request, or any other situation which indicates that an update to the software application may be needed.

At S220, it is determined whether the incident can be remedied with an online-deployable software patch. This determination may leverage the expertise of one or more software developers. The determination at S220 may also include determination of whether resources should be expended to address the issue in an expedited manner (i.e., does the issue constitute a true emergency). If the result of either determination is false, flow proceeds to S230. At S230, the incident report is addressed through other customer service/development procedures.

Flow proceeds to S240 if it is determined at S220 that the issue can and should be remedied expeditiously. At S240, one or more developers develop a software patch for resolving the issue using any suitable development tools. S240 also includes executing local tests on the software patch. Local testing may comprise executing one or more static code checks and unit tests on the software patch, but embodiments are not limited thereto.

It is determined at S250 whether the software patch passed the local tests. If not, flow returns to S240 to modify the patch accordingly. Flow cycles between S240 and S250 until it is determined that the software patch passes the local tests. Next, at S260, the patch is deployed to a deployment test landscape. In some embodiments, the patch is bundled with necessary files, scripts, and metadata which may identify dependencies. The bundled package (or transport) may be transferred to the deployment test landscape manually, using CI/CD pipelines, using application-specific transport tools, etc.

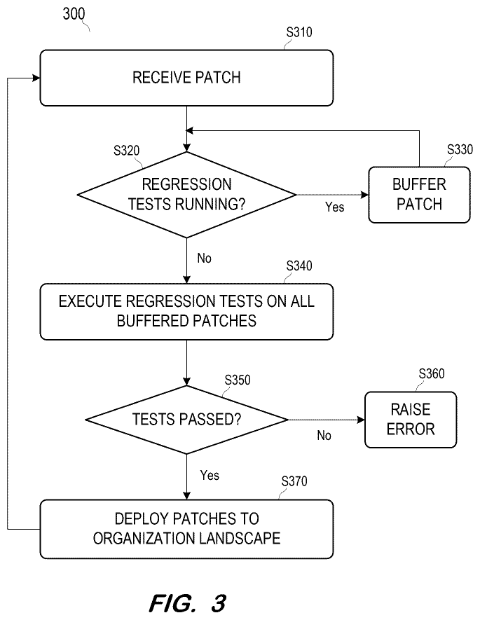

FIG. 3 is a flow diagram of a process to test and deploy software patches according to some embodiments. A software patch is received at S310. In some embodiments, the software patch may be received at a deployment test landscape after being deployed thereto at S260 of process 200.

In response to reception of the patch, it is determined at S320 whether any regression tests are currently running in the deployment test landscape. If so, the received patch is stored in a buffer at S330. Flow pauses at S320 until a determination is made that regression testing is complete. During this pause, additional patches may be received at S310 and, because regression testing is ongoing, these additional patches are also stored in the buffer at S330. According to some embodiments, a patch is buffered upon receipt at a development test landscape, regardless of whether or not regression testing is currently executing.

Flow proceeds to S340 once it is determined that regression tests are not running. At S340, regression tests are executed based on all patches which are currently stored in the buffer. For example, the software application is patched with all patches currently stored in the buffer, the patched software application is assembled, and the software application is deployed within the deployment test landscape. Regression testing is performed on the deployed software application, which may include smoke tests, UI test automates, and any other regression testing that is or becomes known.

New patches may be received during execution of the regression tests at S340. These new patches are buffered as described above until a next determination is made that regression testing is complete. If it is determined at S350 that the regression tests did not pass, an error is raised at S360. The error may be transmitted to the patch developers, IT administrators, etc.

If the regression tests passed (e.g., executed without errors), the tested patches are deployed to an organization landscape at S370. The deployment may require manual approval based on the regression test results or, in some embodiments, may occur automatically. Patch deployment may comprise installing the patched software application to the organization landscape, updating the software application in-place based on the patch, or any other technique.

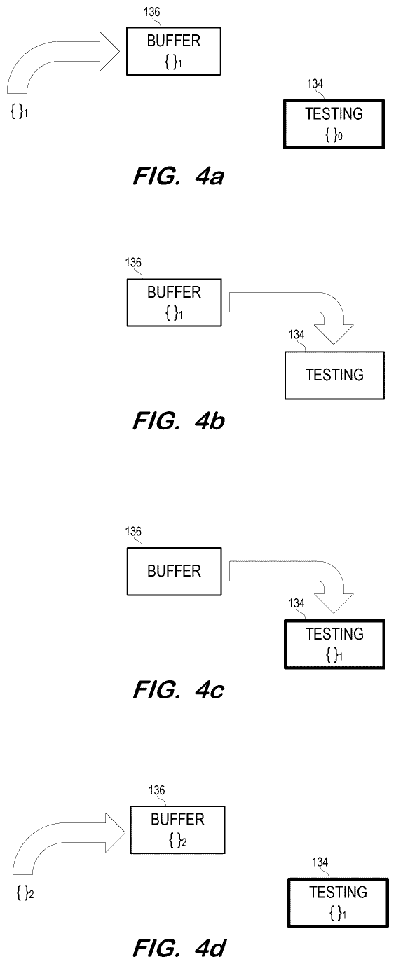

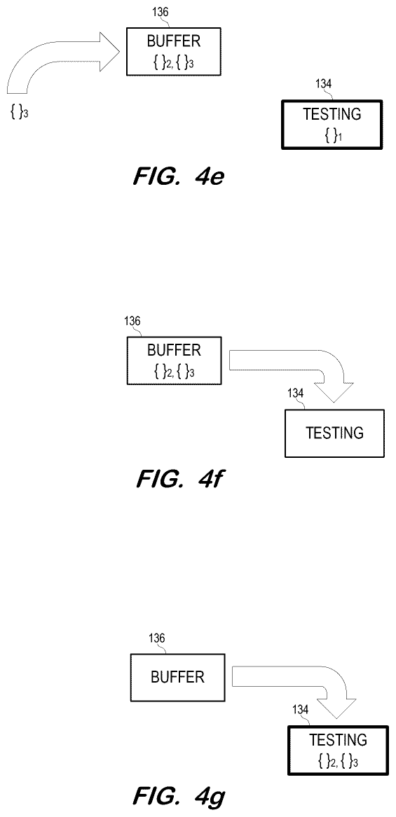

FIG. 4a through 4f illustrate an example of process 300 according to some embodiments. As illustrated in FIG. 4a, received patch { }₁ is initially stored in buffer 136 and because testing component 134 is currently performing regression testing on a software application patched with patch { }₁. The regression testing then terminates as shown in FIG. 4b. In response, patch { }₁ is used to patch the software application and testing component 134 begins regression testing of the patched software application as shown in FIG. 4c.

It is now assumed that a second patch { }₂ is received. The second patch { }₂ is stored in buffer 136 as shown in FIG. 4d because testing component 134 is currently conducting regression testing on the software application patched by patch { }₁. Patch { }₂ remains in buffer 136 while testing component 134 conducts regression testing on the software application patched by patch { }₁.

While testing component 134 conducts regression testing on the software application patched by patch { }₁, and as illustrated in FIG. 4e, third patch { }₃ is received and stored in buffer 136. It is now assumed that regression testing of patch { }₁ is completed as shown in FIG. 4f. In response to completion of the regression testing, the software application (already patched with patch { }₁) is patched with patches { }₂ and { }₃ and testing component 134 begins regression testing of the thusly-patched software application as shown in FIG. 4g.

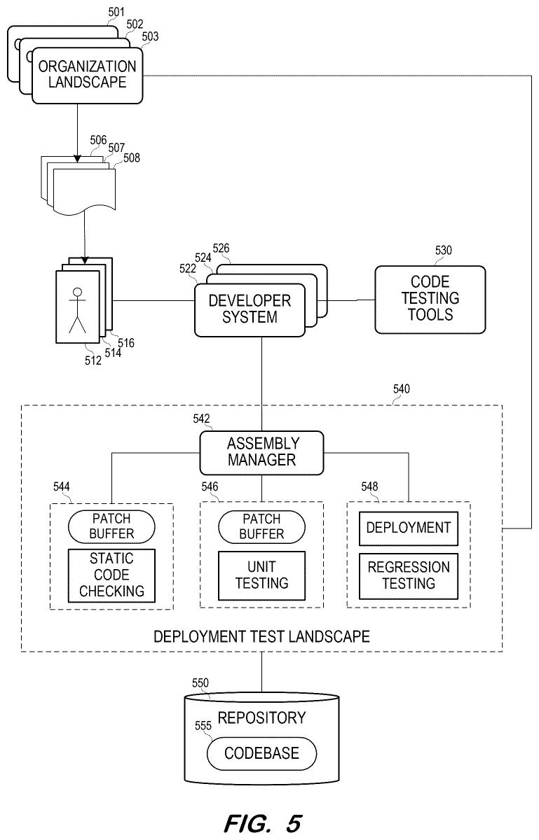

FIG. 5 is a block diagram of an architecture for software patch development and testing according to some embodiments. It is assumed that a particular software application is deployed and executing on several different organization landscapes 501, 502, 503. The organizations may or may not be related. As described above, incident reports 506, 507, 508 may originate from one or more of organization landscapes 501, 502, 503, indicating issues with the software application.

According to FIG. 5, a development team consisting of developers 512, 514, 516 evaluates incident reports 506, 507, 508 and determines that one or more patches may be developed and deployed to remedy one or more of the issues. Developers 512, 514, 516 operate developer systems 522, 524, 526 and code testing tools 530 to develop the one or more patches and perform local static code checks and unit testing thereon.

As described above, the one more patches are forwarded to assembly manager 542 of development test landscape 540. Landscape 540 includes static code checking landscape 544, unit testing landscape 546 and regression testing landscape 548. Assembly manager 542 stores the one or more patches in the patch buffer of landscape 544 and, in response, the static code checking component of landscape 544 executes static code checks on the entire software application as patched by the one or more patches. The static code checking component may access codebase 555 of repository 550 to execute the static code checks.

Assembly manager 542 also stores the one or more patches in the patch buffer of landscape 546. In response, the unit testing component of landscape 546 executes unit tests on the entire software application as patched by the one or more patches. Regression testing landscape 548 may operate to deploy the patched software application to deployment test landscape 540 and to perform regression testing thereon as described above. If all tests are passed, the patched software application may then be deployed to customer landscapes 506, 507, 508.

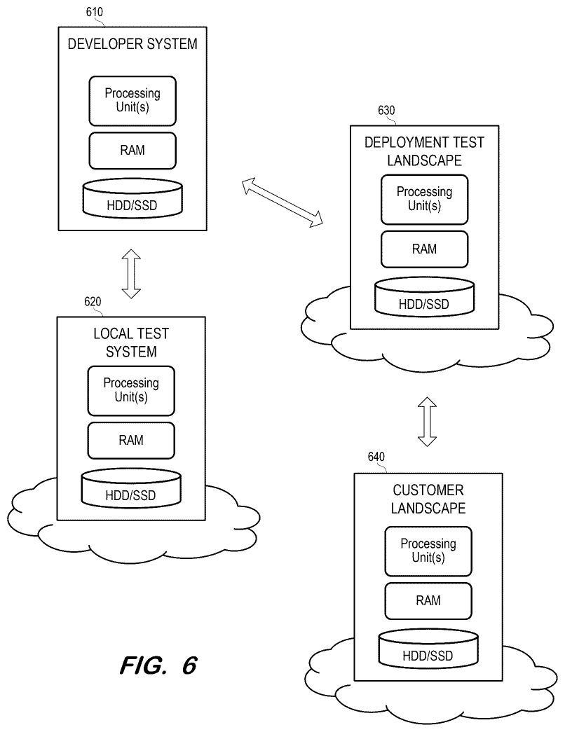

FIG. 6 is a diagram of a cloud-based implementation according to some embodiments. Developer system 610 may comprise a local computing system operated by a developer to develop software patches as described above. Developer system 610 may access local test system 620 to perform local unit tests and static code checks on the developed patches. Developer system 610 may transport the patches to deployment test landscape 630, which may operate as described herein to perform regression testing based on the patches. Deployment test landscape 630 may also deploy patched software applications to customer landscape 640.

Each of systems 620, 630, 640 may comprise cloud-based resources residing in one or more public clouds providing self-service and immediate provisioning, autoscaling, security, compliance and identity management features. Systems 620, 630, 640 may comprise servers or virtual machines of respective Kubernetes clusters, but embodiments are not limited thereto.

The foregoing diagrams represent logical architectures for describing processes according to some embodiments, and actual implementations may include more or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation of a system according to some embodiments may include a processor to execute program code such that the computing device operates as described herein.

All systems and processes discussed herein may be embodied in program code stored on one or more non-transitory computer-readable recording media. Such media may include, for example, a hard disk, a DVD-ROM, a Flash drive, magnetic tape, and solid-state Random Access Memory (RAM) or Read Only Memory (ROM) storage units. Embodiments are therefore not limited to any specific combination of hardware and software.

Embodiments described herein are solely for the purpose of illustration. Those in the art will recognize other embodiments may be practiced with modifications and alterations to that described above.

What is claimed is:

1. A system comprising:
a memory storing processor-executable program code; and
at least one processing unit to execute the processor-executable program code to cause the system to:
receive a first software code patch for a software application in a buffer;
in response to reception of the first software code patch, determine that a regression test of the software application is executing;
receive a second software code patch for the software application in the buffer;
in response to reception of the second software code patch, determine that a regression test of the software application is not executing; and
in response to the determination that the regression test is not executing, automatically execute a regression test of the software application patched with the first software code patch and the second software code patch.

2. The system of claim 1, the at least one processing unit to execute the processor-executable program code to cause the system to:
determine that the regression test of the software application patched with the first software code patch and the second software code patch passed; and
in response to the determination that the regression test of the software application patched with the first software code patch and the second software code patch passed, automatically deploy the first software code patch and the second software code patch to a customer landscape.

3. The system of claim 1, the at least one processing unit to execute the processor-executable program code to cause the system to:
while the regression test of the software application patched with the first software code patch and the second software code patch executes:
receive a third software code patch for the software application in the buffer; and
in response to reception of third second software code patch, determine that regression test of the software application patched with the first software code patch and the second software code patch is executing;
determine that the regression test of the software application patched with the first software code patch and the second software code patch is not executing;
in response to the determination that the regression test of the software application patched with the first software code patch and the second software code patch is not executing, automatically execute a regression test of the software application patched with the third software code patch.

4. The system of claim 3, the at least one processing unit to execute the processor-executable program code to cause the system to:
determine that the regression test of the software application patched with the first software code patch and the second software code patch passed;
in response to the determination that the regression test of the software application patched with the first software code patch and the second software code patch passed, automatically deploy the first software code patch and the second software code patch to a customer landscape;
determine that the regression test of the software application patched with the third software code patch passed; and
in response to the determination that the regression test of the software application patched with the third software code patch passed, automatically deploy the third software code patch to the customer landscape.

5. The system of claim 1, wherein the regression testing comprises automated user interface tests.

6. The system of claim 1, the at least one processing unit to execute the processor-executable program code to cause the system to:
prior to receipt of the first software code patch in the buffer:
receive the first software code patch in a second buffer;
in response to reception of the first software code patch in the second buffer, execute a static code check of the software application patched with the first software code patch;
receive the first software code patch in a third buffer; and
in response to reception of the first software code patch in the third buffer, execute unit tests of the software application patched with the first software code patch.

7. The system of claim 6, the at least one processing unit to execute the processor-executable program code to cause the system to:
determine that the regression test of the software application patched with the first software code patch and the second software code patch passed; and
in response to the determination that the regression test of the software application patched with the first software code patch and the second software code patch passed, automatically deploy the first software code patch and the second software code patch to a customer landscape.

8. A method comprising:
receiving a first software code patch for a software application in a buffer;
in response to receiving the first software code patch, determining that a regression test of the software application is executing;
receiving a second software code patch for the software application in the buffer;
in response to receiving the second software code patch, determining that the regression test of the software application is executing;
waiting for the regression test of the software application to complete; and
in response to completion of the regression test, automatically executing a regression test of the software application patched with the first software code patch and the second software code patch.

9. The method of claim 8, further comprising:
determining that the regression test of the software application patched with the first software code patch and the second software code patch passed; and
in response to determining that the regression test of the software application patched with the first software code patch and the second software code patch passed, automatically deploying the first software code patch and the second software code patch to a customer landscape.

10. The method of claim 8, further comprising:
while the regression test of the software application patched with the first software code patch and the second software code patch is executing:
receiving a third software code patch for the software application in the buffer;
waiting for the regression test of the software application patched with the first software code patch and the second software code patch to complete; and
in response to completion of the regression test of the software application patched with the first software code patch and the second software code patch, automatically executing a regression test of the software application patched with the third software code patch.

11. The method of claim 10, further comprising:
determining that the regression test of the software application patched with the first software code patch and the second software code patch passed;
in response to determining that the regression test of the software application patched with the first software code patch and the second software code patch passed, automatically deploying the first software code patch and the second software code patch to a customer landscape;
determining that the regression test of the software application patched with the third software code patch passed; and
in response to determining that the regression test of the software application patched with the third software code patch passed, automatically deploying the third software code patch to the customer landscape.

12. The method of claim 8, wherein the regression testing comprises automated user interface tests.

13. The method of claim 8, further comprising:
prior to receiving the first software code patch in the buffer:
receiving the first software code patch in a second buffer;
in response to receiving the first software code patch in the second buffer, executing a static code check of the software application patched with the first software code patch;
receiving the first software code patch in a third buffer; and
in response to receiving the first software code patch in the third buffer, executing unit tests of the software application patched with the first software code patch.

14. The method of claim 13, further comprising:
determining that the regression test of the software application patched with the first software code patch and the second software code patch passed; and
in response to determining that the regression test of the software application patched with the first software code patch and the second software code patch passed, automatically deploying the first software code patch and the second software code patch to a customer landscape.

15. One or more computer-readable recording media storing processor-executable program code, the program code executable by a computing system to cause the computing system to perform operations comprising:
receiving a first software code patch for a software application in a buffer;
in response to receiving the first software code patch, determining that a regression test of the software application is executing;
receiving a second software code patch for the software application in the buffer;
in response to receiving the second software code patch, determining that the regression test of the software application is executing;
waiting for the regression test of the software application to complete; and
in response to completion of the regression test, automatically executing a regression test of the software application patched with the first software code patch and the second software code patch.

16. The one or more computer-readable recording media of claim 15, the operations further comprising:
determining that the regression test of the software application patched with the first software code patch and the second software code patch passed; and
in response to determining that the regression test of the software application patched with the first software code patch and the second software code patch passed, automatically deploying the first software code patch and the second software code patch to a customer landscape.

17. The one or more computer-readable recording media of claim 15, the operations further comprising:
while the regression test of the software application patched with the first software code patch and the second software code patch is executing:
receiving a third software code patch for the software application in the buffer;
waiting for the regression test of the software application patched with the first software code patch and the second software code patch to complete; and
in response to completion of the regression test of the software application patched with the first software code patch and the second software code patch, automatically executing a regression test of the software application patched with the third software code patch.

18. The one or more computer-readable recording media of claim 17, the operations further comprising:
determining that the regression test of the software application patched with the first software code patch and the second software code patch passed;
in response to determining that the regression test of the software application patched with the first software code patch and the second software code patch passed, automatically deploying the first software code patch and the second software code patch to a customer landscape;
determining that the regression test of the software application patched with the third software code patch passed; and
in response to determining that the regression test of the software application patched with the third software code patch passed, automatically deploying the third software code patch to the customer landscape.

19. The one or more computer-readable recording media of claim 15, wherein the regression testing comprises automated user interface tests.

20. The one or more computer-readable recording media of claim 15, the operations further comprising:
prior to receiving the first software code patch in the buffer:
receiving the first software code patch in a second buffer;
in response to receiving the first software code patch in the second buffer, executing a static code check of the software application patched with the first software code patch;
receiving the first software code patch in a third buffer; and
in response to receiving the first software code patch in the third buffer, executing unit tests of the software application patched with the first software code patch.
